(19) United States
(12) Patent Application Publication
(10) Pub. No.: US 2026/0313443 A1
(43) Pub. Date: Oct. 8, 2026

(54) DYNAMIC QOS PROFILE SWITCH IN DYNAMIC SCS

(71) Applicant: Samsung Electronics Co., Ltd., Suwon-si (KR)

(72) Inventors: Yue Qi, Plano, TX (US); Rubayet Shafin, Frisco, TX (US); Peshal Nayak, Plano, TX (US); Vishnu Vardhan Ratnam, Frisco, TX (US); Boon Loong Ng, Plano, TX (US); Bilal Sadiq, Plano, TX (US)

(21) Appl. No.: 19/577,108

(22) Filed: Mar. 24, 2026

Related U.S. Application Data
(60) Provisional application No. 63/783,766, filed on Apr. 4, 2025.
(60) Provisional application No. 63/786,048, filed on Apr. 9, 2025.
(60) Provisional application No. 63/794,800, filed on Apr. 25, 2025.
(60) Provisional application No. 63/796,747, filed on Apr. 29, 2025.
(60) Provisional application No. 63/829,531, filed on Jun. 24, 2025.
(60) Provisional application No. 63/883,448, filed on Sep. 17, 2025.

(51) Int. Cl. H04W 28/02; H04W 8/18

(52) U.S. Cl. CPC H04W 28/0268; H04W 8/18

(57) ABSTRACT

Methods and apparatuses for dynamic quality of service (QoS) profile switch in dynamic stream classification service (SCS). A method performed by a first station (STA) includes transmitting, to a second STA, an indication including information indicating a switch from a first QoS profile to a second QoS profile. The first QoS profile and the second QoS profile are from the same or different SCS streams, and the first QoS profile and the second QoS profile are profiles that have been previously negotiated between the first STA and the second STA as profiles for the SCS streams. The method includes receiving, from the second STA, a response to the indication to switch from the first QoS profile to the second QoS profile, and switching from the first QoS profile to the second QoS profile based on the received response.

### CROSS-REFERENCE TO RELATED APPLICATION(S) AND CLAIM OF PRIORITY

This application claims priority under 35 U.S.C. § 119 (e) to U.S. Provisional Patent Application No. 63/783,766, filed on Apr. 4, 2025, U.S. Provisional Patent Application No. 63/786,048, filed on Apr. 9, 2025, U.S. Provisional Patent Application No. 63/794,800, filed on Apr. 25, 2025, U.S. Provisional Patent Application No. 63/796,747, filed on Apr. 29, 2025, U.S. Provisional Patent Application No. 63/829,531, filed on Jun. 24, 2025, and U.S. Provisional Patent Application No. 63/883,448, filed on Sep. 17, 2025. The above identified provisional patent applications are hereby incorporated by reference in their entirety.

### TECHNICAL FIELD

This disclosure relates generally to wireless communication, and more specifically to dynamic quality of service (QoS) profile switch in dynamic stream classification service (SCS).

### BACKGROUND

Wireless Local Area Network (WLAN) technology allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for dynamic QoS profile switch in dynamic SCS.

In one embodiment, a method performed by a first station (STA) includes transmitting, to a second STA, an indication including information indicating a switch from a first quality of service (QoS) profile to a second QoS profile. The first QoS profile and the second QoS profile are from the same or different stream classification service (SCS) streams, and the first QoS profile and the second QoS profile are profiles that have been previously negotiated between the first STA and the second STA as profiles for the SCS streams. The method includes receiving, from the second STA, a response to the indication to switch from the first QoS profile to the second QoS profile, and switching from the first QoS profile to the second QoS profile based on the received response to the indication to switch from the first QoS profile to the second QoS profile.

In another embodiment, a method performed by a second STA includes receiving, from a first STA, an indication including information indicating a switch from a first quality of service (QoS) profile to a second QoS profile. The first QoS profile and the second QoS profile are from the same or different stream classification service (SCS) streams, and the first QoS profile and the second QoS profile are profiles that have been previously negotiated between the first STA and the second STA as profiles for the SCS streams. The method includes transmitting, to the first STA, a response to the indication to switch from the first QoS profile to the second QoS profile, and preparing to switch from the first QoS profile to the second QoS profile based on the received indication to switch from the first QoS profile to the second QoS profile.

In yet another embodiment, a first STA comprises at least one processor including processing circuitry, and memory storing instructions. The instructions, when executed by the at least one processor individually or collectively, cause the first STA to transmit, to a second STA, an indication including information indicating a switch from a first quality of service (QoS) profile to a second QoS profile, where the first QoS profile and the second QoS profile are from the same or different stream classification service (SCS) streams, and the first QoS profile and the second QoS profile are profiles that have been previously negotiated between the first STA and the second STA as profiles for the SCS streams. The instructions, when executed by the at least one processor individually or collectively, further cause the first STA to receive, from the second STA, a response to the indication to switch from the first QoS profile to the second QoS profile, and switch from the first QoS profile to the second QoS profile based on the received response to the indication to switch from the first QoS profile to the second QoS profile.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example frame exchange according to embodiments of the present disclosure;

FIG. 4 illustrates an example traffic identifier (TID) subfield format according to embodiments of the present disclosure;

FIG. 5 illustrates an example QoS enhancement subfield format according to embodiments of the present disclosure;

FIG. 6 illustrates an example BlockAck starting sequence number subfield format according to embodiments of the present disclosure;

FIG. 7 illustrates an example feedback subfield format for dynamic QoS profile switch feedback according to embodiments of the present disclosure;

FIG. 8 illustrates an example feedback format for low latency switch feedback subfield according to embodiments of the present disclosure;

FIG. 9 illustrates an example of encoding of QoS profile ID according to embodiments of the present disclosure;

FIG. 10 illustrates an example format for QoS enhancement in the BlockAck frame according to embodiments of the present disclosure;

FIG. 11 illustrates an example an example frame exchange according to embodiments of the present disclosure;

FIG. 12 illustrates an example format for QoS switch request in the BlockAck frame according to embodiments of the present disclosure;

FIG. 13 illustrates an example feedback subfield format for dynamic QoS profile switch request in the BlockAck request according to embodiments of the present disclosure;

FIG. 14 illustrates an example format of an initial control frame for QoS enhancement according to embodiments of the present disclosure;

FIG. 15 illustrates an example format of a control response frame for QoS enhancement according to embodiments of the present disclosure;

FIG. 16 illustrates an example format of the dynamic QoS profile in the aggregate control (A-control) field according to embodiments of the present disclosure;

FIG. 17 illustrates an example format of the dynamic QoS profile field in the A-control field according to embodiments of the present disclosure;

FIG. 18 illustrates an example format of the dynamic QoS profile field in the enhanced buffer status report (EBSR) control field according to embodiments of the present disclosure;

FIG. 19 illustrates an example format of the dynamic QoS profile field in the command and status (CAS) control field according to embodiments of the present disclosure;

FIG. 20 illustrates an example frame exchange according to embodiments of the present disclosure;

FIG. 21 illustrates an example format of a QoS character element according to embodiments of the present disclosure;

FIG. 22 illustrates an example format of a dynamic QoS A-control field according to embodiments of the present disclosure;

FIG. 23 illustrates an example frame exchange according to embodiments of the present disclosure; and

FIG. 24 illustrates an example method performed by a STA in a wireless communication system according to embodiments of the present disclosure.

### DETAILED DESCRIPTION

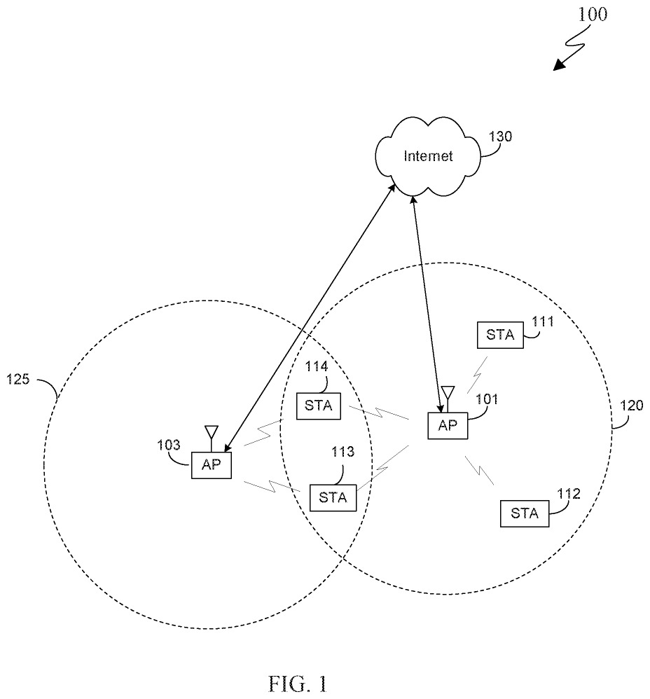

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE 802.11-2020, “Wireless LAN Medium Access Control (MAC) and Physical Layer (PHY) Specification.”

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for supporting dynamic QoS profile switch in dynamic SCS. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

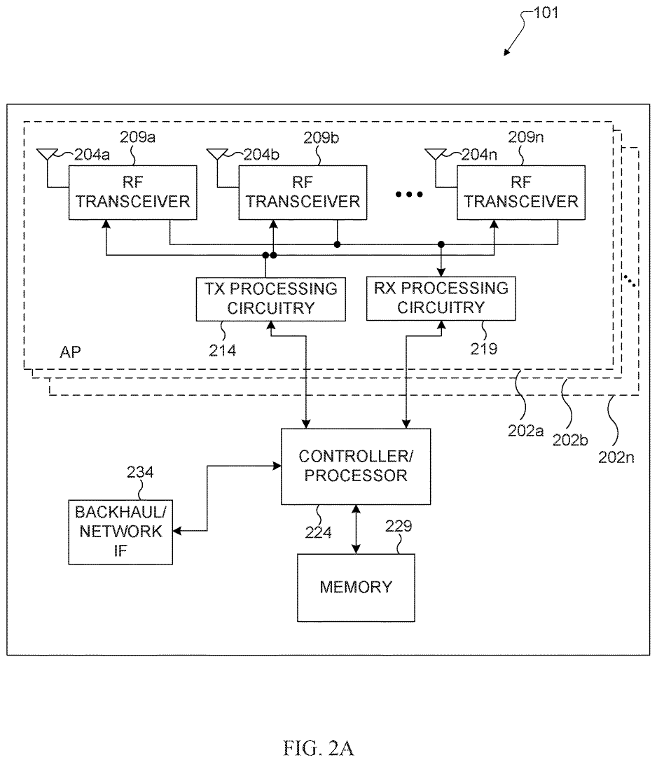

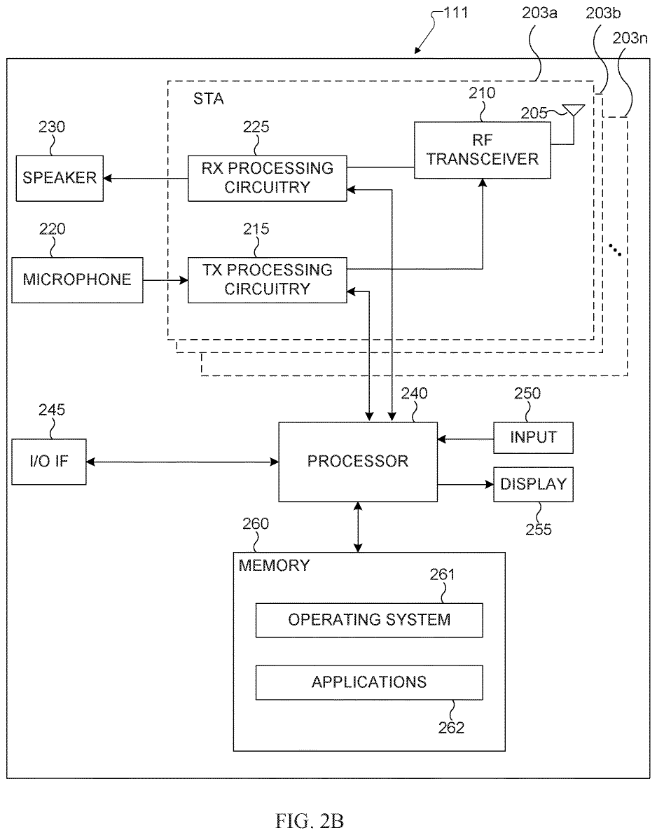

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHZ, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including anchor link design for multi-link operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for supporting dynamic QoS profile switch in dynamic SCS. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to support dynamic QoS profile switch in dynamic SCS. In some embodiments, the processor 240 includes at least one microprocessor or microcontroller.

The processor 240 is also capable of executing other processes and programs resident in the memory 260, such as operations for supporting dynamic QoS profile switch in dynamic SCS dynamic QoS profile switch in dynamic SCS. The processor 240 can move data into or out of the memory 260 as required by an executing process. In some embodiments, the processor 240 is configured to execute a plurality of applications 262, such as applications for supporting dynamic QoS profile switch in dynamic SCS. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure recognize that in the discussions for the latest Wi-Fi standard IEEE 802.11bn, a significant focus has been given for the need to reduce the channel access delay for low-latency traffic required by real-time applications (RTAs). In fact, the approved PAR for IEEE 802.11bn intends to define at least one mode of operation capable of improving the tail of the latency distribution and jitter compared to Extremely High Throughput MAC/PHY operation. Therefore, reducing the low latency for the increasing demand of real-time application (RTA) is important in 11bn:
The need for 11bn includes: “more stringent requirements are needed to meet the demands of new applications (including metaverse, augmented and virtual reality, robotics, industrial automation for industrial IoT, logistics and smart agriculture)”.
Lower latency leading to better customer experience (especially worst-case latency/jitter mattering).
Low latency communication becoming essential building block for RTA. According to KPI and PAR discussions, shown as the table below, some use cases requires at least less than 5 ms for latency and 2 ms for jitter.

Various embodiments of the present disclosure recognize that the SCS with QoS Characteristics procedure defined in IEEE 802.11be is for Quasi-static traffic flow, i.e., the underlying assumption is that the traffic characteristics do not change too frequently. However, there are many scenarios where the users' traffic patterns change too frequently.

Accordingly, various embodiments of the present disclosure provide detailed signaling for dynamic SCS switch indication which may allow for a non-AP STA to dynamically change QoS expectation or QoS flow with the associated AP.

An ultra-high reliability (UHR) STA may indicate a switch from one QoS profile to another using some control frame.

According to one embodiment, the indication frame may include the indication information such as an indication of the QoS Switch.

According to another embodiment, the indication may carry one or more of the context information such as up-to-date QoS Profile ID, the latest SCS, the latest QoS character element, the previous QoS Profile ID, the different information between the up-to-date and previous QoS Profiles, etc.

According to one embodiment, a switch indication from an existing profile to one or more requested dynamic QoS Profile IDs may be indicated in the Multi-STA BlockAck frame. According to one variant of the embodiment, a switch indication from an existing profile to one or more requested dynamic QoS Profile IDs may be indicated in the feedback field.

According to one embodiment, a switch indication or request from an existing profile to one or more requested dynamic QoS Profile IDs may be indicated in the BA frame.

According to one embodiment, a switch indication or request from an existing profile to one or more requested dynamic QoS Profile IDs may be indicated in the BAR frame.

According to one embodiment, the indication frame may include information such as QoS Profile Switch in the request and response information.

According to one embodiment, a switch indication or request from an existing profile to one or more requested dynamic QoS Profile IDs may be indicated in the variant of RTS/CTS frames.

According to one embodiment, a switch indication or request from an existing profile to one or more requested dynamic QoS Profile IDs may be indicated in the variant of the A-control field.

According to one embodiment, a switch indication or request from an existing profile to one or more requested dynamic QoS Profile IDs may be indicated in the variation of the PS-Poll frame.

According to one embodiment, a switch indication or request from an existing profile to one or more requested dynamic QoS Profile IDs may be indicated in the variation of trigger-based UL methods.

According to one embodiment, a switch indication or request from an existing profile to one or more requested dynamic QoS Profile IDs may be indicated in the variation of the enhanced BSR.

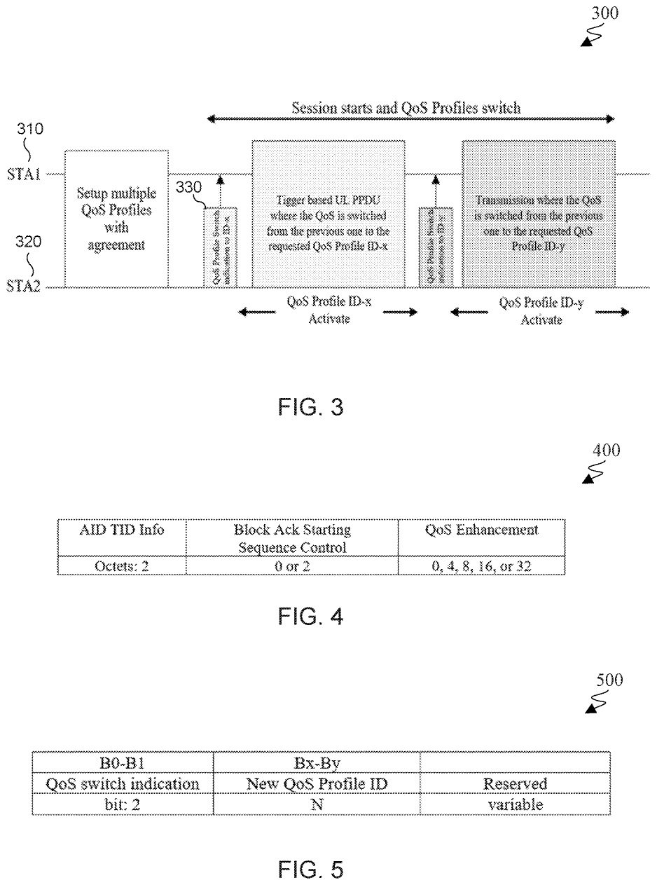

FIG. 3 illustrates an example frame exchange 300 according to embodiments of the present disclosure. The embodiment of the example frame exchange 300 of FIG. 3 is for illustration only. Different embodiments of an example frame exchange 300 could be used without departing from the scope of this disclosure.

In general, the indication frame may be considered in a control response frame. An example frame exchange is shown in FIG. 3. The QoS Profile Switch Indication 330 is indicated in a control response frame, for example, BA, Multi-STA BA, CTS, etc. After the indication, the STA1 310, for example, an AP may trigger the STA2 320 with the latest QoS and schedule with the requested resources.

In one embodiment, a default QoS Profile ID is activated after the negotiation. In one variant of the embodiment, a specific QoS Profile, such as the first QoS Profile ID, can be set as the default value. The default QoS Profile may be selected from the negotiation procedure. The default QoS Profile may be the lowest QoS Profile. The default QoS Profile may be average or the highest QoS Profile.

In one embodiment, a default QoS Profile can be activated or started when the Session begins.

In one embodiment, if one or more QoS Profiles get rejected, the AP may provide an update or suggestion of the parameters to the STA for acceptance. In a variant of the embodiment, if one or more QoS Profiles get rejected, the STA may provide an update, e.g., downgrade the QoS Profiles, of the parameters to re-negotiate for acceptance.

FIG. 4 illustrates an example TID subfield format 400 according to embodiments of the present disclosure. The embodiment of the example TID subfield format 400 of FIG. 4 is for illustration only. Different embodiments of an example TID subfield format 400 could be used without departing from the scope of this disclosure.

According to one embodiment, the switch indication may be included in the BA Information field of the BlockAck frame.

According to one embodiment, a new set of Ack Type subfield and or TID subfield may indicate the dynamic QoS switch or QoS enhancement or QoS indication information instead of acknowledgement status. For example, a Per AID TID Info field may have the Ack Type subfield equal to 0 and the TID subfield equal to 12.

According to one embodiment, the new combination may include QoS enhancement information instead of Acknowledgement status (see Table 9-39 (Context of the Per AID TID Info subfield and presence of optional subfields if the AID11 subfield is not 2045)).

According to anther embodiment, the AID11 subfield of the AID TID Info subfield is set to the AID of a UHR STA that is the intended receiver of the QoS feedback information or to 2009 or other reserved value if the information is intended for all receiving UHR STAs.

A value of 2009 or other reserved value in the AID11 subfield may be used to identify a Per AID TID Info field that carries QoS indication information that applies to all receiving UHR STAs.

If the AID11 subfield of the AID TID Info subfield is not 2045, and if the Ack Type subfield is equal to 0 and the TID subfield is equal to 12 then the Per AID TID Info subfield may have the format shown in FIG. 4 (per AID TID Info subfield format if the AID11 subfield is not 2045 and if the combination of the Ack Type subfield is equal to 0 and the TID subfield is equal to 12 respectively).

A QoS enhancement subfield is included in the Per AID TID Info field instead of a Block Ack Bitmap subfield. The QoS Enhancement subfield may include one or more information items shown in Table 1.

TABLE 1
Information items in QoS Enhancement subfield.

| Information items | Introduction | Encoding examples |
|---|---|---|
| QoS Switch | An indication item notifying | A bit equals to one |
| Indication | the TXOP holder of switching | indicating there is a need for |
| | the QoS to a request new SCS | QoS switch. A bit equals to |
| | profile which has been agreed | 0 indicating no switch |
| | in the negotiation procedure. | needs. |
| New QoS Profile | An information item which | Several bits or octets which |
| ID | includes the latest QoS Profile | include the QoS Profile ID. |
| | ID. | It may also be included in |
| | | the AID TID Info. Or in the |
| | | TID_Info field of the BA |
| | | Control field of the multi- |
| | | STA BlockAck field. |
| New QoS Profile | An information item or more | Several bits or octets which |
| ID Updating or | information items which | include the different |
| Changing Delta | include the differences of the | information between the |
| | Element or subfields between | previous and new QoS |
| | the previous QoS Profile and | Profile. |
| | the latest QoS Profile. | |
| QoS Profile Info | An information item which | Several bits or octets which |
| field | includes most or all of the | include the information in |
| | latest QoS Profile details, for | the request switched QoS |
| | example, one or more | Profile ID |
| | information or subfields in the | |
| | QoS Characteristic Element | |
| | that are different from the | |
| | previous QoS Profile ID. | |
| SCS ID | An information item which | It may be included in the |
| | includes the general SCS ID. | AID TID Info. Or in the |
| | | TID_Info field of the BA |
| | | Control field of the multi- |
| | | STA BlockAck field. |

FIG. 5 illustrates an example QoS enhancement subfield format 500 according to embodiments of the present disclosure. The embodiment of the example QoS enhancement subfield format 500 of FIG. 5 is for illustration only. Different embodiments of an example QoS enhancement subfield format 500 could be used without departing from the scope of this disclosure.

As shown in FIG. 5, the QoS enhancement subfield may have a format that includes a QoS switch indication field, a new QoS profile ID field, and a reserved field.

According to another example, the information in the AID TID Info may include the latest QoS Profile ID.

In one embodiment, the dynamic QoS switch may be in a new Per AID TID Info field.

In one embodiment, the new Per AID TID Info field may include a combination of Ack Type subfield and TID subfield may be used to indicate the dynamic QoS switch.

An example of the new combination may be the Ack Type subfield equal to 0 and the TID subfield equal to 13, in which the feedback type may include a new type as Dynamic QoS Switch feedback.

In one embodiment, the AID11 field of the QoS Profile Info may be equal to the same special AID value as the AID field of Feedback Per AID TID Info field.

In one embodiment, the special AID TID field may be positioned after the Per AID TID Info field which carries the acknowledge context of the M-STA BA.

In one embodiment, the special AID TID field may be positioned before the Per AID TID Info field which carries the acknowledge context of the M-STA BA.

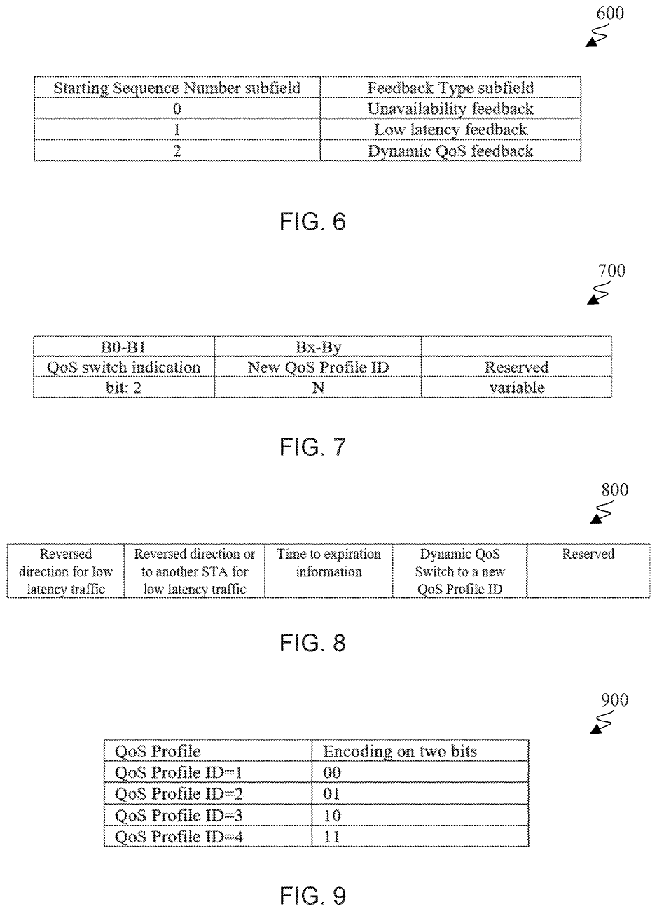

FIG. 6 illustrates an example BlockAck starting sequence number subfield format 600 according to embodiments of the present disclosure. The embodiment of the example BlockAck starting sequence number subfield format 600 of FIG. 6 is for illustration only. Different embodiments of an example BlockAck starting sequence number subfield format 600 could be used without departing from the scope of this disclosure.

According to another embodiment, the Dynamic QoS profile Switch subfield or Dynamic QoS feedback may be encoded as one of the Feedback Type subfields.

According to one example of the embodiment, it may be located in the Block Ack Starting Sequence Control subfield. An example is shown in FIG. 6.

FIG. 7 illustrates an example feedback subfield format 700 for dynamic QoS profile switch feedback according to embodiments of the present disclosure. The embodiment of the example feedback subfield format 700 for dynamic QoS profile switch feedback of FIG. 7 is for illustration only. Different embodiments of an example feedback subfield format 700 for dynamic QoS profile switch feedback could be used without departing from the scope of this disclosure.

If the Feedback Type subfield is 2, the Feedback subfield may have the format example as shown in FIG. 7. The Dynamic QoS Profile Switch feedback may include the dynamic QoS Profile information.

FIG. 8 illustrates an example feedback format 800 for low latency switch feedback subfield according to embodiments of the present disclosure. The embodiment of the example feedback format 800 for low latency switch feedback subfield of FIG. 8 is for illustration only. Different embodiments of an example feedback format 800 for low latency switch feedback subfield could be used without departing from the scope of this disclosure.

According to another embodiment, the dynamic QoS Profile information may be included in the Feedback subfield as one or more encoding of the Low Latency Indication subfield. A value or more may indicate the new Profile ID. An example is shown in FIG. 8.

FIG. 9 illustrates an example of encoding of QoS profile ID 900 according to embodiments of the present disclosure. The embodiment of the example of encoding of QoS profile ID 900 of FIG. 9 is for illustration only. Different embodiments of an example of encoding of QoS profile ID 900 could be used without departing from the scope of this disclosure.

According to one embodiment, the Dynamic QoS Profile may have several numbers with different QoS Profile ID, for example, they may have different IDs.

According to another embodiment, the Dynamic QoS Profile may be encoded as a sequence number. For example, three different QoS Profiles are encoded as 0, 1, 2. According to another variant of the example, two bits may be used for encoding four kinds QoS Profiles. The LLI subfield may reserve 2 bits to indicate the QoS profile IDs. An example for a default value of four QoS Profile IDs is shown in FIG. 9.

According to one embodiment, the TID_INFO may be set as the requested QoS Profile ID in the Multi-STA BlockAck frame.

According to one embodiment, the TID_INFO may be changed to the QoS_Profile ID.

According to one embodiment, the switch indication may be included in the BA Information field of the BlockAck frame.

According to another embodiment, a new variant of BA type instead of acknowledging may be used for dynamic QoS. For example, the BA Type of the BA Control field in the BlockAck frame may be set as QoS Profile indication.

According to another embodiment, the TID_Info may be changed to the SCS ID for dynamic QoS.

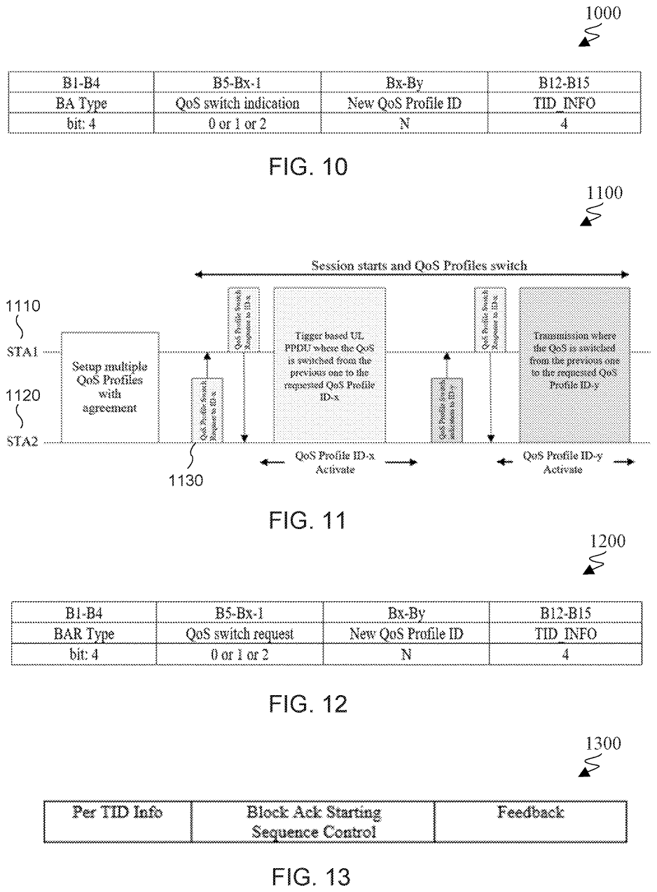

FIG. 10 illustrates an example format 1000 for QoS enhancement in the BlockAck frame according to embodiments of the present disclosure. The embodiment of the example format 1000 for QoS enhancement in the BlockAck frame of FIG. 10 is for illustration only. Different embodiments of an example format 1000 for QoS enhancement in the BlockAck frame could be used without departing from the scope of this disclosure.

According to one embodiment, the dynamic QoS may be indicated in the BA Control field of the BlockAck frame. For example, using some of the reserved bits after the BA Type field. An example is shown in FIG. 10.

According to one embodiment, the TID_INFO may be set as the requested QoS Profile ID in the BlockAck frame.

According to one embodiment, the TID_INFO may be changed to the QoS_Profile ID.

FIG. 11 illustrates an example frame exchange 1100 according to embodiments of the present disclosure. The embodiment of the example frame exchange 1100 of FIG. 11 is for illustration only. Different embodiments of an example frame exchange 1100 could be used without departing from the scope of this disclosure.

According to another embodiment, the indication frame may be considered in a request frame. An example frame exchange is shown in FIG. 11. The QoS Profile Switch Indication 1130 is included in some request frame, for example, BAR, RTS, or a variant of the BAR, or RTS, or a new Dynamic SCS Switch request frame, etc. After sending the switch request frame 1130 with the updated QoS Profile from STA2 1120 to STA1 1110, the STA1 1110, for example, may respond to the request frame by updating the latest QoS and schedule with the requested resources. The STA1 may also have a chance to reject the request, or it may reply with a partial accept if it may not satisfy the new QoS Profile.

According to one embodiment, the QoS Profile Switch Request frame may be included in the BAR frame.

According to one embodiment, the switch indication may be included in the BAR Information field of the BlockAckReq frame.

According to one embodiment, the switch indication may be included in the BA Control field of the BlockAckReq frame.

In one embodiment, a QoS Profile Switch field may be used to indicate if the request or response frame support the QoS Profile Switch. If there is a QoS Profile Switch field or any field equals to one which may indicate as an enablement or capability of the QoS Profile Switch. Otherwise, the field may be set as zero.

FIG. 12 illustrates an example format 1200 for QoS switch request in the BlockAck frame according to embodiments of the present disclosure. The embodiment of the example format 1200 for QoS switch request in the BlockAck frame of FIG. 12 is for illustration only. Different embodiments of an example format 1200 for QoS switch request in the BlockAck frame could be used without departing from the scope of this disclosure.

According to one embodiment, the dynamic QoS request may be indicated in the BAR Control field of the BlockAck frame. For example, using some of the reserved bits after the BAR Type field. An example is shown in FIG. 12.

According to one embodiment, the TID_INFO may be set as the requested QoS Profile ID in the BlockAckReq frame.

According to one embodiment, the TID_INFO may be changed to the QoS_Profile ID.

According to another embodiment, the dynamic QoS request may be included as a new BAR Type.

According to one embodiment, the dynamic QoS switch request may be included in the BAR Information field.

FIG. 13 illustrates an example feedback subfield format 1300 for dynamic QoS profile switch request in the BlockAck request according to embodiments of the present disclosure. The embodiment of the example feedback subfield format 1300 for dynamic QoS profile switch request in the BlockAck request of FIG. 13 is for illustration only. Different embodiments of an example feedback subfield format 1300 for dynamic QoS profile switch request in the BlockAck request could be used without departing from the scope of this disclosure.

A new Multi-TID BlockAckReq or a new Multi-TID BlockAckReq frame may be used to include the QoS Profile Switch request.

According to one embodiment, the new combination may include QoS Profile Switch request information instead of Acknowledgement. As an example of the embodiment, the Multi-TID subfield value equals to 1 or 0, the Compressed Bitmap subfield value equals to 1 or 0, and/or the GCR Mode subfield value equals to xx, the BlockAckReq frame variant can be set as requested Feedback or QoS request. An example of the frame is shown in FIG. 13.

According to one embodiment, the Per TID Info may include the request QoS Profile ID.

According to another embodiment, the Feedback Request may include the information discussed herein, such as with respect to FIG. 7, FIG. 8, and FIG. 9.

In one embodiment, the BA may serve as a response to the BAR with the QoS Profile Switch request.

The response code may include Accept, Partial Accept or Accept with variance, Reject, or Suggest. The code explanation can be found in Table 2.

TABLE 2
Response code

| Information items | Introduction |
|---|---|
| Accept | This is to re-confirm that the negotiated |
| | QoS Profile will be supported as agreed. |
| Accept with | This is to indicate that the negotiated QoS |
| variance | Profile will still be supported with |
| | conditions or trade off. For example, If the |
| | AP is forced to meet stringent delay |
| | constraints of the highest profile (using |
| | highest QoS for all packets) but cannot do |
| | so, it may average the resources for all |
| | requests. |
| Reject | It may reject the negotiated QoS Profile if |
| | the STA or the AP may not be able to |
| | support as the agreement. |
| Suggest | It may also suggest the STA had |
| | dynamically downgraded its QoS profile |
| | with a more relaxed delay bound, the AP |
| | could have adjusted scheduling |

In one embodiment, the QoS Switch Response may be included in the requested Feedback, or it may include QoS Profile Switch field.

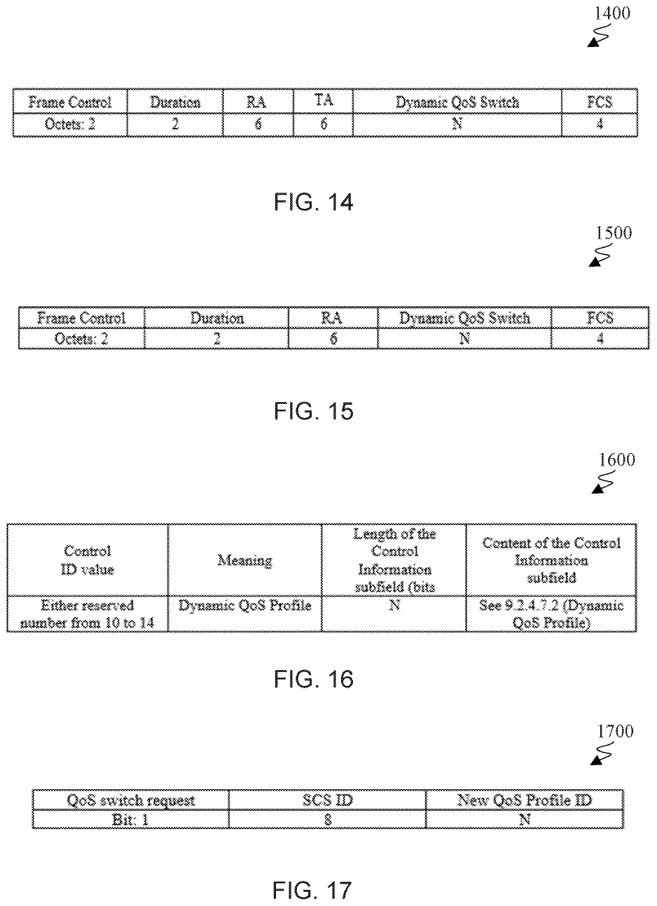

FIG. 14 illustrates an example format 1400 of an initial control frame for QoS enhancement according to embodiments of the present disclosure. The embodiment of the example format 1400 of an initial control frame for QoS enhancement of FIG. 14 is for illustration only. Different embodiments of an example format 1400 of an initial control frame for QoS enhancement could be used without departing from the scope of this disclosure.

FIG. 15 illustrates an example format 1500 of a control response frame for QoS enhancement according to embodiments of the present disclosure. The embodiment of the example format 1500 of a control response frame for QoS enhancement of FIG. 15 is for illustration only. Different embodiments of an example format 1500 of a control response frame for QoS enhancement could be used without departing from the scope of this disclosure.

According to one embodiment, the Dynamic QoS Profile ID or a Switch indication may be included in a variant of RTS or CTS frame format. Examples of the initial control frame and control response frame are shown in FIG. 14 and FIG. 15, in which the Dynamic QoS Switch field is a new field included in the RTS frame.

The Dynamic QoS Switch field may include the information discussed herein, such as with respect to FIG. 7, FIG. 8, and FIG. 9.

FIG. 16 illustrates an example format 1600 of the dynamic QoS profile in the A-control field according to embodiments of the present disclosure. The embodiment of the example format 1600 of the dynamic QoS profile in the A-control field of FIG. 16 is for illustration only. Different embodiments of an example format 1600 of the dynamic QoS profile in the A-control field could be used without departing from the scope of this disclosure.

FIG. 17 illustrates an example format 1700 of the dynamic QoS profile field in the A-control field according to embodiments of the present disclosure. The embodiment of the example format 1700 of the dynamic QoS profile field in the A-control field of FIG. 17 is for illustration only. Different embodiments of an example format 1700 of the dynamic QoS profile field in the A-control field could be used without departing from the scope of this disclosure.

In one embodiment, the QoS Switch information may be included in the A-Control field.

A new Control ID subfield value may indicate the Dynamic QoS Profile. An example is shown in FIG. 16. The example of the Dynamic QoS Profile field is shown in FIG. 17.

According to one embodiment, the Dynamic QoS Profile may be considered as a variant of other A-Control fields. For example, the BSR Control field, the CAS Control subfield may use the reserved bits. N reserved bits in these control fields such as enhanced BSR control field, CAS Control field may be used for dynamic QoS Profile.

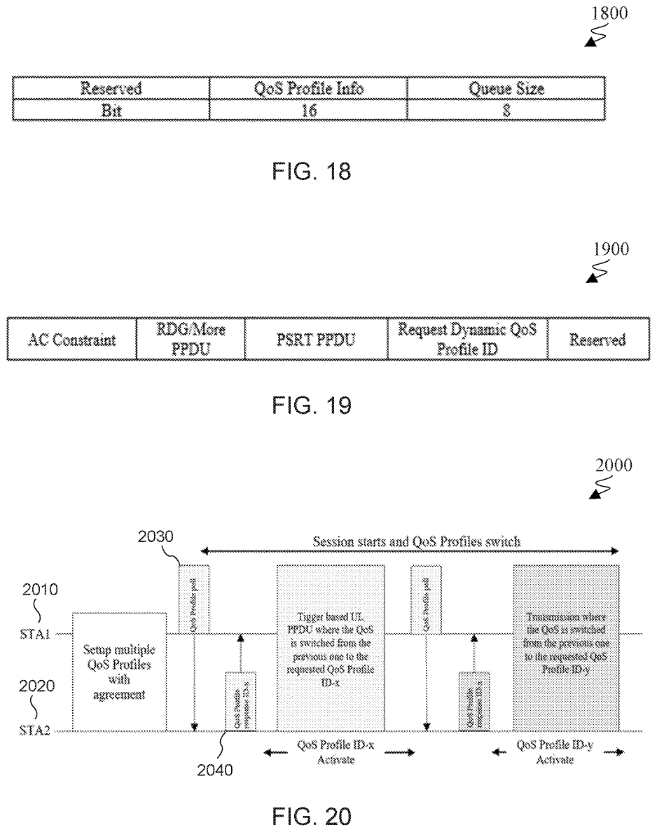

FIG. 18 illustrates an example format 1800 of the dynamic QoS profile field in the EBSR control field according to embodiments of the present disclosure. The embodiment of the example format 1800 of the dynamic QoS profile field in the EBSR control field of FIG. 18 is for illustration only. Different embodiments of an example format 1800 of the dynamic QoS profile field in the EBSR control field could be used without departing from the scope of this disclosure.

In one embodiment, the Dynamic QoS Profile can be considered in the Control Information field of the EBSR Control field, as shown in FIG. 18.

FIG. 19 illustrates an example format 1900 of the dynamic QoS profile field in the CAS control field according to embodiments of the present disclosure. The embodiment of the example format 1900 of the dynamic QoS profile field in the CAS control field of FIG. 19 is for illustration only. Different embodiments of an example format 1900 of the dynamic QoS profile field in the CAS control field could be used without departing from the scope of this disclosure.

According to one embodiment, the Dynamic QoS Profile may be considered as a variant of the CAS Control subfield using the reserved bits. N reserved bits in the CAS Control field may be used for the dynamic QoS Profile. An example is shown in FIG. 19. According to a variant of the embodiment, other A-Control field with reserved bits may be used for the dynamic QoS Profile.

FIG. 20 illustrates an example frame exchange 2000 according to embodiments of the present disclosure. The embodiment of the example frame exchange 2000 of FIG. 20 is for illustration only. Different embodiments of an example frame exchange 2000 could be used without departing from the scope of this disclosure.

In one embodiment, the AP or the non-AP STA may poll or approach or trigger to the STA for any request to switch to the latest QoS Profile. For example, STA1 2010 may send a QoS probe request 2030 to STA2 2020 to switch to the latest QoS profile. The STA2 2020 may send a QoS probe response 2040 to the STA1 2010.

In one embodiment, the trigger frame may be considered. In one example of the embodiment, the BSRP and BSR frames may include the QoS enhancement, QoS Profile Switch information and some other information listed in the above Sections as some new fields. In another example of the embodiment, the trigger frame such as QoS Poll frames may include the QoS enhancement, QoS Profile Switch information, and so on.

In one embodiment, a basic trigger frame may be considered as a container of the QoS Enhancement, where the UORA as the UL OFDMA may be used for multiple dynamic QoS Switch indication for multiple STAs or multiple TIDs.

In one embodiment, the BSRP Trigger frame and MBA frame be the frame exchanges by transmitting an initial Control frame (ICF) and initial control response frame (ICR) allowed for dynamic QoS. The trigger frame may have the UL Length field set to a value that is sufficiently large to allow the STA to include in the PPDU that is sent in response an ICR that can include QoS Profile information.

In one embodiment, a dynamic QoS request non-AP STA that is operating in the dynamic SCS session, and that receives, from the supporting AP, a BSRP Trigger frame that is individually addressed to the STA and solicits a response in non-HT (duplicate) PPDU format may include a Multi-STA BA frame.

A dynamic SCS non-AP STA that is operating in the dynamic SCS session and that is a TxOP responder may indicate, in a response Multi-STA BlockAck frame, about which Qos Profile Info needs to be switched from the current QoS Profile to. For example, the QoS Profile ID, the set of information that is being changed.

A dynamic SCS requesting non-AP STA that is operating in the dynamic SCS and that is a TxOP holder may indicate in a BSRP Trigger frame about which QoS Profile Info needs to be switched from the current QoS Profile to. The dynamic SCS requesting non-AP STA may transmit this BSRP Trigger frame when certain conditions are true.

In one example of the embodiment of the conditions, the STAs have successfully negotiated the D-SCS QoS Profiles in the negotiation stage.

In another embodiment of the negotiation stage, the non-AP STA is the dynamic QoS requesting STA, and the AP is the responding STA which will support the non-AP STA with a dynamic SCS switch.

In another embodiment, the peer STAs either AP or non-AP STA may support the QoS Profile Info and the dot11QoSProfile equals to true.

In one embodiment, if the AP is a TxOP responder, it may support that a STA can be a TXOP holder and sending the trigger-based frame.

The QoS Profile Info field may be included in one or more of the User Info fields of the BSRP Trigger frame.

In one embodiment, the User Info field of the BSRP containing the indication information may be included in the Special User Info field, or the UHR variant User Info field.

In one embodiment, the Special User Info field may contain a Feedback Type field of the “Special User Info” field which may be set to a number, e.g., 2, to indicate that the “Special User Info” field is carrying the dynamic QoS Profile Information. Number 0 is for DUO, number 1 may be for low latency indication.

The User Info field of the BSRP, for example, a Special User Info field, containing the indication information such as DUO, Low latency, dynamic QoS, or enhanced BSR, etc., may include the information of the legacy BSRP or information in Table 3.

TABLE 3
User Info field of BSRP with feedback information.

| Information | |
|---|---|
| items | Introduction |
| QoS Profile | The BSRP trigger frame may include the |
| Info | Trigger Dependent User Info field of the User |
| | Info field, which was not presented. The QoS |
| | Profile Info and other feedbacks may be |
| | included. |
| SCS ID | The User Info field may include the SCSID in |
| | the trigger frame. |

The response frame to such a BSRP Trigger frame with feedbacks such as dynamic QoS information, low latency information, etc., is a Multi-STA BlockAck frame in non-HT (duplicate) PPDU format.

The above conditions may also apply to DUO and low latency indication.

When a dynamic SCS supporting AP receives from a dynamic SCS requesting non-AP STA a Multi-STA BlockAck frame addressed to the AP, in response to a preceding BSRP Trigger frame, that includes a QoS Profile field, the UHR AP may consider the STA with one or more of the following conditions:
switch from the current QoS Profile to the new QoS Profile indicated in the QoS Profile Info field,
for a duration and or frequency in the QoS Profile Info field, or in the dynamic QoS Characteristics.
for a maximum data rate or a variance data rate or any related changed information in the dynamic QoS Characteristics.

When a dynamic SCS supporting AP receives from a dynamic SCS requesting non-AP STA a BSRP trigger frame addressed to the UHR AP, which include a QoS Profile field, the responding AP may consider in response a Multi-STA BlockAck frame to the requesting STA with one or more of the following conditions:
switch from the current QoS Profile to the new QoS Profile indicated in the QoS Profile Info field,
for a duration and or frequency in the QoS Profile Info field, or in the dynamic QoS Characteristics.
for a maximum data rate or a variance data rate or any related changed information in the dynamic QoS Characteristics.

When a dynamic SCS supporting peer STA receives from a dynamic SCS requesting non-AP STA a BSRP trigger frame addressed to the peer non-AP STA with the requesting dynamic SCS and indication of dynamic SCS switch, in response to the BSRP Trigger frame, that includes a QoS Profile field, the responding non-AP STA may consider the STA with one or more of the following conditions:
switch from the current QoS Profile to the new QoS Profile indicated in the QoS Profile Info field,
for a duration and or frequency in the QoS Profile Info field, or in the dynamic QoS Characteristics.
for a maximum data rate or a variance data rate or any related changed information in the dynamic QoS Characteristics.

According to one embodiment, the individual addressed BSRP trigger frame may be used for soliciting the Dynamic QoS response such as switch indication, D-SCS response, etc., the trigger frame may set the GI and HE/EHT/UHR-TLF Type subfield of the Common Info field to 3. Then the PPDU sent in response to the BSRP Trigger frame is a non-HT (duplicate) PPDU that contains a Multi-STA BlockAck frame.

In one embodiment, a Multi-STA BA frame may include both Block Ack Bitmap and Feedback information if the preceding PPDU includes QoS Data frame(s) that solicit an immediate response and the STA is operating in the dynamic QoS session or mode that allows inclusion of feedback information such as the dynamic QoS.

In one embodiment, a BSRP trigger frame may include a special User Info, or Feedback information, or a UHR User Info field and other info if the trigger frame is soliciting both non-HT PPDU and also the acknowledgement with the Feedback information and the STA is operating in the dynamic QoS session or mode that allows the inclusion of the feedback information.

The indication of the QoS Profile field and low latency indication is carried in the Common Info field of the BSRP Trigger frame.

In one embodiment, one or more of the multiple feedback types such as unavailability, low latency, enhanced BSR, dynamic QoS Profile switch, etc., may be included in one multi-STA BA frame.

In one embodiment, a field may indicate that there may be multiple feedback types in one MBA. For example, if the field, e.g., multi-feedback type, is set to 0, one feedback or one new Per AID TID field is included. Otherwise, multiple is considered by setting the field equals to 1.

In one embodiment, there is a limit of the Per AID TID fields, for example, two at a time, can be included in one multi-STA BA frame for efficiency purpose.

The combination of the fields may also indicate different use cases. In one embodiment, the combination of the fields should be regulated.

For example, if the Block Ack Starting Sequence Number subfield value is 0, feedback type is DUO. Simultaneously, if the Block Ack Starting Sequence Number subfield value is 1, feedback type is Low Latency indication. If both of them exist, a TXOP sharing or link termination may be considered.

In another example, if the Block Ack Starting Sequence Number subfield value is 1, feedback type is Low Latency indication. Simultaneously, if the Block Ack Starting Sequence Number subfield value is 2, the feedback type is enhanced BSR, the TXOP holder, may consider correspondingly.

In another example, if the Block Ack Starting Sequence Number subfield value is 1, feedback type is Low Latency indication. Simultaneously, if the Block Ack Starting Sequence Number subfield value is 2, the feedback type is dynamic BSR, the TXOP holder, may consider correspondingly.

In another example, if the Block Ack Starting Sequence Number subfield value is 1, feedback type is Low Latency indication with dynamic QoS Switch enabled. Simultaneously, if the Block Ack Starting Sequence Number subfield value is 2, the feedback type is dynamic BSR, the TXOP holder, may consider the corresponding reply code, or actions.

In another example, if the Block Ack Starting Sequence Number subfield value is 1, feedback type is dynamic QoS Switch enabled. Simultaneously, another feedback type is enhanced BSR, the TXOP holder, may consider the corresponding reply code, or actions.

In another embodiment, the trigger based BSRP may reply with the enhanced BSR and or DUO in MBA. Unsolicited MBA may consider low latency indication and dynamic QoS Switch.

In one embodiment, if the DUO and the LLI are both included in the MBA, a link termination may be considered as an indication or request to the TXOP.

The STA may negotiate with its associated AP with some limitations on using the DSCS switch indication.

In one embodiment, the STA should refrain from sending indication requests too frequently. For instance, the STA may avoid submitting multiple switch indications within a single TXOP or across several TXOPs.

The Minimum Indication Request Interval is the minimum time between the QoS Profile switch indication. This interval of the switch indication or SCS request may be indicated by the STA or AP, and STA may negotiate or update with the AP.

The Service Request Frozen period is a field that indicates a period that the Switch Indication may be frozen or prohibit at the STA side. During the Frozen Period, the STA may not be able to send the switch indication. The starting, end, medium or duration of the Frozen Period may be included in the QoS Char. Element.

The AP may indicate the starting time or end time of the Frozen period. STA may indicate to froze the switch if it may process other events such as Co-ex or P2P or DUO.

The Service Request Retry counter is a counter if the Switch indication have not been processed and the STA tries to send it again. The STA may allow to resend the same indication request within the maximum number of Retry limit. A Retry Limit may also be included in the field.

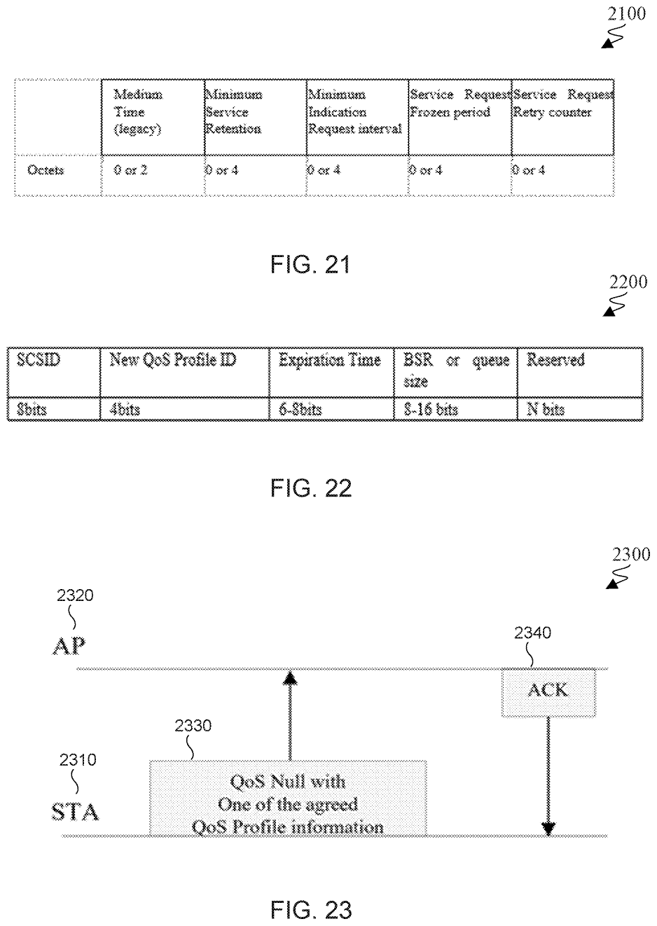

FIG. 21 illustrates an example format 2100 of a QoS character element according to embodiments of the present disclosure. The embodiment of the example format 2100 of a QoS character element of FIG. 21 is for illustration only. Different embodiments of an example format 2100 of a QoS character element could be used without departing from the scope of this disclosure.

In one embodiment, the STA may also maintain a QoS Status for a minimum amount of time. A minimum duration that the STA plans to maintain the QoS status may be negotiated or indicated, for example, fields such as QoS Retention Period or Minimum Service Retention in the QoS Char Element as shown in FIG. 21.

In one embodiment, the STA may also request to “add” or “update” an SCS based on the Minimum Service Retention field, Service Request Interval, etc.

In one embodiment, the AP may delay the acknowledge for the QoS Profile Switch request.

In one embodiment, the AP may send an implicit Ack in the next PPDU or MSDU or a trigger frame indicating the receiving of the STA's indication but may not provide an update at this moment.

In one embodiment, the AP may send an explicit Ack indicating a delay of the request. In one embodiment, the AP may also suggest a time stamp or start time or service duration or other resources to allocate the traffic in the next subsequent TXOPs.

In one embodiment, the AP may ignore or reject the acknowledge for the QoS Profile Switch request.

In one embodiment, the AP may not need to send an Ack to the indication, and the AP does not need to take any immediate actions.

In one embodiment, the AP may not need to send an Ack to the indication, and the AP does not need to take any actions if the resources are limited or the request from one or more STAs are in high QoS requirements.

In one embodiment, the AP may send a rejection if the resources are limited or the request from one or more STAs are in high QoS requirements. If the AP sends a rejection of the indication, after the retry limit or if the STA has not reached the retry counter, the STA may resend the indication again. The STA may resend the indication after the Minimum Indication Request interval. The STA may resend the indication after the Minimum Service Retention indicating in the current QoS Profile or the requested QoS Profile or the maximum of the Minimum Service Retention.

In one embodiment, when the AP receives the QoS Profile Switch request, it may send a delayed response.

In one embodiment, the AP and STA may negotiate a wait time such as an Indication_Response_Timeout, and the AP may send the response anytime by the timeout value.

In one embodiment, the AP may also suggest a starting time or period in triggering, response, or indicating of scheduling.

In one embodiment, a new A-control subfield can be considered for dynamic SCS switch indication. An example term is SCS Switch Control (SSC) or Dynamic QoS Control (DQoS).

In one embodiment, a new Control ID subfield may indicate for SSC or DQoS field.

In one embodiment, a Switch To Profile ID or requested QoS Profile field may indicate the new profile that the current profile is switched to.

In one embodiment, a Switch From Profile ID or current QoS Profile may indicate the current profile ID or the profile that the STA plans to switch from.

In one embodiment, the SCSID, TID, Link ID, QoS Profile ID, etc., may be included in the A-Control field.

In one embodiment, the Parameter Tweak field indicates some the deltas or differences such as delay bound delta or the data rate differences.

In one embodiment, an Urgency level is indicated to show how urgency this switch can be treated. For example, if the STA requires to switch from a high to low QoS, in which the requested QoS may be less sensitive and can have a longer waiting time for AP triggering.

In another variant of the embodiment, a Maximum Waiting Time may be included for the AP to consider.

In another embodiment, the expiration time or time to expiration may be included for the AP to consider.

FIG. 22 illustrates an example format 2200 of a dynamic QoS A-control field according to embodiments of the present disclosure. The embodiment of the example format 2200 of a dynamic QoS A-control field of FIG. 22 is for illustration only. Different embodiments of an example format 2200 of a dynamic QoS A-control field could be used without departing from the scope of this disclosure.

As shown in FIG. 22, in another embodiment, the Expiration time, BSR or queue size may be considered in the Dynamic QoS A-control field.

In one embodiment, the A-Control info field may be included in the MAC header of any frame such as Data frame, a PPDU, QoS Data frame, QoS Null frame, management frame such as SCS request or response, or control frame, etc.

According to one embodiment, the Dynamic QoS Profile may be considered as a variant of other A-Control fields. For example, the reserved bits in BSR Control field, CAS Control subfield, or AAR Control field may be used for including the QoS Switch Indication information or Dynamic QoS Profile information such as one or more of the QoS Profile ID, TID, SCSID, Link ID, etc. N reserved bits in these control field such as enhanced BSR control field, CAS Control field, AAR Control field.

FIG. 23 illustrates an example frame exchange 2300 according to embodiments of the present disclosure. The embodiment of the example frame exchange 2300 of FIG. 23 is for illustration only. Different embodiments of an example frame exchange 2300 could be used without departing from the scope of this disclosure.

As shown in FIG. 23, in one embodiment, the indication frame may be designed using a QoS Null frame with D-QoS A-control field. The STA 2310 may send the QoS Null frame 2330 with one of the agreed Dynamic QoS Profile Info field to the AP 2320, where the DQoS Field is an A-Control field. The AP 2320 may provide an ACK 2340 for processing the switch.

In one embodiment, the indication frame may be designed using QoS Null frame with the information in some header or in the frame body, or in a designed special User Info field or added Per AID TID field.

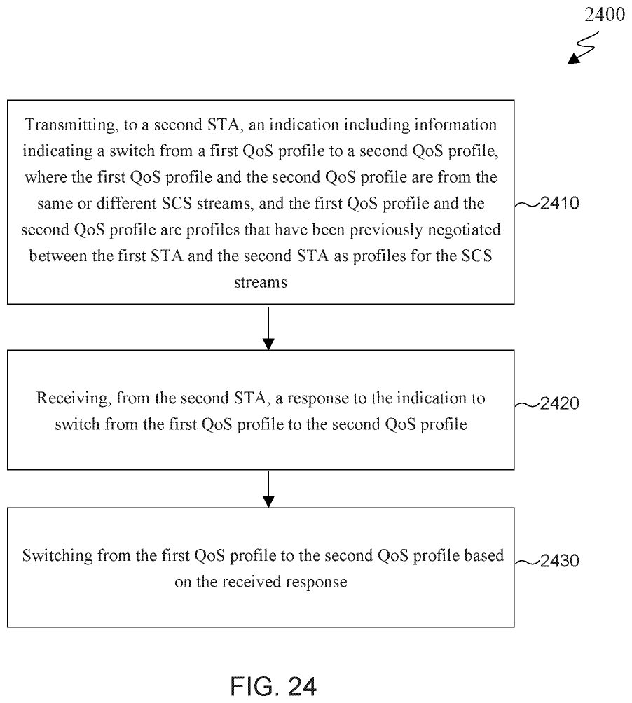

FIG. 24 illustrates an example method 2400 performed by a first station (STA) in a wireless communication system according to embodiments of the present disclosure. The method 2400 of FIG. 24 can be performed by any of the STAs 111-114 of FIG. 1, such as the STA 111 of FIG. 2B, or by any of the APs 101-103 of FIG. 1, such as AP 101 of FIG. 2A. The method 2400 is for illustration only and other embodiments can be used without departing from the scope of the present disclosure.

As illustrated in FIG. 24, the method 2400 begins at step 2410, where the first STA transmits, to a second STA, an indication including information indicating a switch from a first quality of service (QoS) profile to a second QoS profile. The first QoS profile and the second QoS profile are from the same or different stream classification service (SCS) streams, and the first QoS profile and the second QoS profile are profiles that have been previously negotiated between the first STA and the second STA as profiles for the SCS streams. At step 2420, the first STA receives, from the second STA, a response to the indication to switch from the first QoS profile to the second QoS profile. At step 2430, the first STA switches from the first QoS profile to the second QoS profile based on the received response to the indication to switch from the first QoS profile to the second QoS profile.

In some embodiments, the information indicating a switch from the first QoS profile to the second QoS profile includes at least one of information of the switch from the first QoS profile to the second QoS profile, current QoS profile identification information, previous QoS profile identification information, QoS profile identification information that includes differences between a previous QoS profile and a current QoS profile, QoS Characteristics element information, and SCS identification information.

In some embodiments, the first STA includes the indication indicating a switch from the first QoS profile to the second QoS profile in a Multi-STA BlockAck frame.

In some embodiments, the first STA includes the indication indicating a switch from the first QoS profile to the second QoS profile in a Per association identifier (AID) traffic identifier (TID) Info field of the Multi-STA BlockAck frame, and includes multiple per AID TID Info fields in the Multi-STA BlockAck frame to report different types of feedback information.

In some embodiments, the first STA includes the indication indicating a switch from the first QoS profile to the second QoS profile in an aggregated control (A-Control) field.

In some embodiments, the first STA includes the A-Control field in a QoS Null frame.

In some embodiments, the first STA receives a response from the second STA to switch from the first QoS profile to the second QoS profile.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a first station (STA), the method comprising:
transmitting, to a second STA, an indication including information indicating a switch from a first quality of service (QoS) profile to a second QoS profile, wherein:
the first QoS profile and the second QoS profile are from the same or different stream classification service (SCS) streams; and
the first QoS profile and the second QoS profile are profiles that have been previously negotiated between the first STA and the second STA as profiles for the SCS streams;
receiving, from the second STA, a response to the indication to switch from the first QoS profile to the second QoS profile; and
switching from the first QoS profile to the second QoS profile based on the received response to the indication to switch from the first QoS profile to the second QoS profile.

2. The method of claim 1, wherein the information indicating a switch from the first QoS profile to the second QoS profile includes at least one of information of the switch from the first QoS profile to the second QoS profile, current QoS profile identification information, previous QoS profile identification information, QoS profile identification information that includes differences between a previous QoS profile and a current QoS profile, QoS Characteristics element information, and SCS identification information.

3. The method of claim 1, further comprising including the indication indicating a switch from the first QoS profile to the second QoS profile in a Multi-STA BlockAck frame.

4. The method of claim 3, further comprising:
including the indication indicating a switch from the first QoS profile to the second QoS profile in a Per association identifier (AID) traffic identifier (TID) Info field of the Multi-STA BlockAck frame, and
including multiple per AID TID Info fields in the Multi-STA BlockAck frame to report different types of feedback information.

5. The method of claim 1, further comprising including the indication indicating a switch from the first QoS profile to the second QoS profile in an aggregated control (A-Control) field.

6. The method of claim 5, further comprising including the A-Control field in a QoS Null frame.

7. The method of claim 6, further comprising receiving a response from the second STA to switch from the first QoS profile to the second QoS profile.

8. A method performed by a second station (STA), the method comprising:
receiving, from a first STA, an indication including information indicating a switch from a first quality of service (QoS) profile to a second QoS profile, wherein:
the first QoS profile and the second QoS profile are from the same or different stream classification service (SCS) streams; and
the first QoS profile and the second QoS profile are profiles that have been previously negotiated between the first STA and the second STA as profiles for the SCS streams;
transmitting, to the first STA, a response to the indication to switch from the first Qos profile to the second QoS profile; and
preparing to switch from the first QoS profile to the second QoS profile based on the received indication to switch from the first QoS profile to the second QoS profile.

9. The method of claim 8, wherein the information indicating a switch from the first QoS profile to the second QoS profile includes at least one of information of the switch from the first QoS profile to the second QoS profile, current QoS profile identification information, previous QoS profile identification information, QoS profile identification information that includes differences between a previous QoS profile and a current QoS profile, QoS Characteristics element information, and SCS identification information.

10. The method of claim 8, wherein the indication indicating a switch from the first QoS profile to the second QoS profile is included in a Multi-STA BlockAck frame.

11. The method of claim 10, wherein the indication indicating a switch from the first QoS profile to the second QoS profile is included in a Per association identifier (AID) traffic identifier (TID) Info field of the Multi-STA BlockAck frame, and
multiple per AID TID Info fields are included in the Multi-STA BlockAck frame to report different types of feedback information.

12. The method of claim 8, wherein the indication indicating a switch from the first QoS profile to the second QoS profile is included in an aggregated control (A-Control) field.

13. The method of claim 12, wherein the A-Control field is included in a QoS Null frame.

14. The method of claim 13, further comprising transmitting a response to the first STA to switch from the first QoS profile to the second QoS profile.

15. A first station (STA) comprising:
at least one processor including processing circuitry; and
memory storing instructions, wherein the instructions, when executed by the at least one processor individually or collectively, cause the first STA to:
transmit, to a second STA, an indication including information indicating a switch from a first quality of service (QoS) profile to a second QoS profile, wherein:
the first QoS profile and the second QoS profile are from the same or different stream classification service (SCS) streams; and
the first QoS profile and the second QoS profile are profiles that have been previously negotiated between the first STA and the second STA as profiles for the SCS streams;
receive, from the second STA, a response to the indication to switch from the first QoS profile to the second QoS profile; and
switch from the first QoS profile to the second QoS profile based on the received response to the indication to switch from the first QoS profile to the second QoS profile.

16. The first STA of claim 15, wherein the information indicating a switch from the first QoS profile to the second QoS profile includes at least one of information of the switch from the first QoS profile to the second QoS profile, current QoS profile identification information, previous QoS profile identification information, QoS profile identification information that includes differences between a previous QoS profile and a current QoS profile, QoS Characteristics element information, and SCS identification information.

17. The first STA of claim 15, wherein the instructions, when executed by the at least one processor individually or collectively, cause the first STA to include the indication indicating a switch from the first QoS profile to the second QoS profile in a Multi-STA BlockAck frame.

18. The first STA of claim 17, wherein the instructions, when executed by the at least one processor individually or collectively, cause the first STA to:
include the indication indicating a switch from the first QoS profile to the second QoS profile in a Per association identifier (AID) traffic identifier (TID) Info field of the Multi-STA BlockAck frame, and
include multiple per AID TID Info fields in the Multi-STA BlockAck frame to report different types of feedback information.

19. The first STA of claim 15, wherein the instructions, when executed by the at least one processor individually or collectively, cause the first STA to include the indication indicating a switch from the first QoS profile to the second QoS profile in an aggregated control (A-Control) field.

20. The first STA of claim 19, wherein the instructions, when executed by the at least one processor individually or collectively, cause the first STA to include the A-Control field in a QoS Null frame.
